(19) United States
(12) Patent Application Publication
(10) Pub. No.: US 2024/0156117 A1
(43) Pub. Date: May 16, 2024

(54) EDIBLE COATING COMPOSITIONS

(71) Applicant: Apeel Technology, Inc., Goleta, CA (US)

(72) Inventors: Anthony Crisci, Goleta, CA (US); Daniel Essert, Goleta, CA (US); David Fisher, Goleta, CA (US); Derek Falcone, Goleta, CA (US); Bardia Soltanzadeh, Goleta, CA (US); David Sandoval, Goleta, CA (US)

(21) Appl. No.: 18/509,887

(22) Filed: Nov. 15, 2023

Related U.S. Application Data
(60) Provisional application No. 63/425,580, filed on Nov. 15, 2022.

(51) Int. Cl. A23B 7/16; A23B 7/154; A23L 3/3517; A23L 29/10

(52) U.S. Cl. CPC A23B 7/16; A23B 7/154; A23L 3/3517; A23L 29/10

(57) ABSTRACT

Compositions and coating mixtures for coating agricultural products, and methods of manufacturing compositions and mixtures are described.

### CROSS-REFERENCE TO RELATED APPLICATION

This application claims the benefit of priority to U.S. Provisional Application No. 63/425,580, filed on Nov. 15, 2022, which is incorporated herein by reference in its entirety.

### TECHNICAL FIELD

This document discloses compositions and coating mixtures for coating agricultural products, and methods of preparing the compositions and coating mixtures.

### BACKGROUND

Common agricultural products are susceptible to degradation and decomposition (i.e., spoilage) when exposed to the environment. Such agricultural products can include, for example, eggs, fruits, vegetables, produce, seeds, nuts, flowers, and/or whole plants (including their processed and semi-processed forms). Non-agricultural products (e.g., vitamins, candy, etc.) are also vulnerable to degradation when exposed to the ambient environment.

Conventional approaches to preventing degradation, maintaining quality, and increasing the life of agricultural products include special packaging and/or refrigeration. Refrigeration requires capital-intensive equipment, demands constant energy expenditure, can cause damage or quality loss to the product if not carefully controlled, must be actively managed, and its benefits are lost upon interruption of a temperature-controlled supply chain. Produce mass loss (e.g., water loss) during storage increases humidity, which necessitates careful maintenance of relative humidity levels (e.g., using condensers) to avoid negative impacts (e.g., condensation, microbial proliferation, etc.) during storage. Moreover, respiration of agricultural products is an exothermic process which releases heat into the surrounding atmosphere. During transit and storage in shipping containers, heat generated by the respiration of the agricultural product, as well as external environmental conditions and heat generated from mechanical processes (e.g., motors) necessitates active cooling of the storage container in order to maintain the appropriate temperature for storage, which is a major cost driver for shipping companies. By reducing the rate of degradation, reducing the heat generation in storage and transit, and increasing the shelf life of agricultural products, there is a direct value to the key stakeholders throughout the supply chain.

### SUMMARY

The disclosure is based, at least in part, on the discovery that a plurality of particles of an edible coating compositions can be formed via melt compounding enabling the elimination of blending ingredients in the powder form and/or via granulating the ingredients/blends of ingredients. The blending of powder ingredients can present challenges due to the different properties and behaviors of each ingredient, e.g., segregation of different compounds can occur at any point in the manufacturing/supply chain process thereby modifying the ratio of components in the formulation and impacting the performance of the final product. The methods of preparing an edible coating composition disclosed herein can eliminate unwanted side reactions and ensure each particle of the edible coating composition is uniform and thus, advantageously the edible coating compositions are uniform batch-to-batch and throughout the supply chain.

Provided herein are edible coating compositions comprising a multiplicity of particles, each particle comprising a homogeneous mixture of: about 50 wt % to about 98 wt % of one or more monoglycerides; and about 1 wt % to about 10 wt % of one or more fatty acid salts.

Also provided herein are methods of preparing an edible coating composition, the method comprising: at least partially melting a material comprising one or more monoglycerides to yield a first mixture; combining the first mixture and one or more fatty acid salts to yield a second mixture; and cooling the second mixture to yield the edible coating composition, wherein the edible coating composition comprises a multiplicity of particles, each particle comprising a homogeneous mixture of the one or more monoglycerides and the one or more fatty acid salts.

Also provided herein are methods of preparing an edible coating composition, the method comprising: combining one or more monoglycerides and one or more fatty acid salts to yield a mixture; heating the mixture to at least partially melt the one or more monoglycerides; mixing the mixture to at least partially melt the one or more fatty acid salts; and; cooling the mixture to yield the edible coating composition, wherein the edible coating composition comprises a multiplicity of particles, each particle comprising a homogeneous mixture of the one or more monoglycerides and the one or more fatty acid salts.

Also provided herein are methods of preparing an edible coating composition, the method comprising: combining one or more particulate monoglycerides and one or more particulate fatty acid salts to yield a mixture comprising a multiplicity of particles; and granulating the mixture to yield the edible coating composition.

There is a need for new, more cost-effective approaches to prevent degradation, reduce the generation of heat and humidity, maintain quality, and increase the life of agricultural products. Embodiments of the edible coating compositions described herein can provide one or more advantages. For example, in some embodiments, the edible coating compositions can protect the agricultural products from biotic stressors, e.g., bacteria, viruses, fungi, or pests. The edible coating compositions can also prevent evaporation of water and/or diffusion of oxygen, carbon dioxide, and/or ethylene. The edible coating compositions can also help extend the shelf life of agricultural products (e.g., post-harvest produce) without refrigeration. The edible coating compositions can reduce the average mass loss rate for the coated agricultural products. The edible coating compositions can also introduce mechanical stability to the surface of the agricultural products eliminating the need for expensive packaging designed to prevent the types of bruising which accelerate spoilage. The edible coating compositions can also be naturally derived, and hence, safe for human consumption. The methods of preparing edible coating compositions disclosed herein can improve batch-to-batch consistency of the final edible coating composition product and/or eliminate unwanted side-reactions during manufacturing/supply chain processes.

The details of one or more embodiments of the subject matter of this disclosure are set forth in the accompanying drawings and the description. Other features, aspects, and advantages of the subject matter will become apparent from the description, the drawings, and the claims.

The section headings used herein are for organizational purposes only and are not to be construed as limiting the subject matter described.

Other features and advantages of the methods and compositions of the disclosure will be apparent from the following detailed description, and from the claims.

### BRIEF DESCRIPTION OF THE DRAWINGS

FIG. 1 shows differential scanning calorimetry (DSC) curves of two different polymorphs of glycerol monostearate.

FIG. 2 is an optical micrograph photographic image of the α-glycerol monostearate.

FIG. 3 is a graph of the turbidity of two different coating compositions over time at different temperatures.

FIG. 4 shows DSC curves of solid phase glycerol monostearate melt compounded with a fatty acid salt.

FIG. 5 is a schematic of a manufacturing process for preparing an edible coating composition disclosed herein.

FIG. 6 is a graph showing the mol % of the total amount of monoglyceride over time in two mixtures including a monoglyceride and a fatty acid salt.

FIG. 7 is a graph showing the turbidity of two edible coating compositions of the disclosure that were prepared differently.

### DETAILED DESCRIPTION

The edible coating compositions disclosed herein are useful for coating agricultural products. In some embodiments, the edible coating compositions include a multiplicity of particles, each particle comprising a homogenous mixture of one or more monoglycerides and one or more fatty acid salts.

### Definitions

Throughout this specification and embodiments, the word “comprise,” or variations such as “comprises” or “comprising,” will be understood to imply the inclusion of a stated integer or group of integers but not the exclusion of any other integer or group of integers.

The term “including” or “includes” is used to mean “including but not limited to.” “Including” and “including but not limited to” are used interchangeably.

Any example(s) following the term “e.g.” or “for example” is not meant to be exhaustive or limiting.

Unless otherwise required by context, singular terms shall include pluralities and plural terms shall include the singular.

The articles “a”, “an”, and “the” are used herein to refer to one or to more than one (i.e., to at least one) of the grammatical object of the article.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., 5.5 to 10.

When the terms “about” and “at least” precede a numeral, these terms also apply to any following numeral or range. For example, “about 1, 2, or 3” means “about 1, about 2, or about 3” and “about 1 to 10, 10 to 20, or 20 to 30” means “about 1 to about 10, about 10 to about 20, or about 20 to about 30.” “At least” is used in the same way.

Each embodiment of this disclosure may be taken alone or in combination with one or more other embodiments of this disclosure.

Exemplary methods and materials are described herein. Methods and materials similar or equivalent to those described herein can also be used in the practice or testing of the various aspects and embodiments. The materials, methods, and examples are illustrative only and not intended to be limiting.

In order for the disclosure to be more readily understood, certain terms are first defined. These definitions should be read in light of the remainder of the disclosure as understood by a person of ordinary skill in the art. Additional definitions are set forth throughout the detailed description.

As used herein, a “homogenous mixture” refers to a uniformly blended mixture that has definite and consistent chemical composition and physical properties in a representative volume element of the mixture. A representative volume element (RVE) is a volume element of a mixture that provides a statistical representation of typical material properties of the mixture. It should be of a volume sufficient to contain enough information on the microstructure yet be sufficiently smaller than the macroscopic structural dimensions of the mixture. For example, the monoglyceride content in a RVE of an edible coating composition disclosed herein is ±1 wt % (e.g., ±0.5 wt %, ±0.1 wt %, or ±0.01 wt %) of each additional RVE sampled from said edible coating composition. For example, the fatty acid salt content in a RVE of an edible coating composition disclosed herein is ±1 wt % (e.g., ±0.5 wt %, ±0.1 wt %, or ±0.01 wt %) of each additional RVE sampled from said edible coating composition.

As used herein, a monoglyceride having a carbon chain length of, for example, about C10 to about C22, refers to the lipophilic portion of the monoglyceride having about 10 carbon atoms to about 22 carbon atoms. For example, a C18 monoglyceride would include glyceryl monostearate because the lipophilic portion of the molecule (e.g., monostearate) has a carbon chain length of 18 carbon atoms, e.g., (C₁₈H₃₅O)—.

As used herein, “glyceryl” refers to a propyl radical substituted with a hydroxyl at each of the two carbon atoms that the radical is not centered on. In some embodiments, a glyceryl is 1-glyceryl (i.e., —CH₂CH(OH)CH₂OH). In some embodiments, a glyceryl is 2-glyceryl (i.e., —CH(CH₂OH)CH₂OH).

As used herein, the term “lecithin” refers to phosphatidylcholine or 1,2-diacyl-glycero-3-phosphocholine. Lecithin, as used herein, can additionally be part of a lecithin mixture which is a natural mixture of neutral and polar lipids (e.g., glycerophospholipids) such as, for example, phosphatidylcholine, phosphatidylethanolamine, phosphatidylinositol, phosphatidylserine, and phosphatidic acid. Phosphatidylcholine can be present in the lecithin mixture in concentrations of about 20 wt % to about 90 wt %. The fatty acids residues of phosphatidylcholine may be saturated, mono-unsaturated or poly-unsaturated. The lecithin and the lecithin mixture can be provided as an oil solution or a de-oiled solution or powder. The lecithin or lecithin mixture in an oil solution includes about 25 wt % to 50 wt % oil. The de-oiled solution includes about 1 wt % to 10 wt % oil or about 5 wt % to 10 wt % oil.

As used herein, the term “lysolecithin” refers to lysophosphatidylcholine. Lysolecithin, as used herein, can additionally be part of a lysolecithin mixture, which is a natural mixture of neutral and polar lipids (e.g., lysophospholipids) such as, for example, lysophosphatidylcholine, lysophosphatidylethanolamine, lysophosphatidylinositol, lysophosphatidylserine and lysophosphatidylglycerol.

As used herein, the term “ammonium phosphatide” refers to one or more ammonium neutralized phosphoric esters of monoglycerides and diglycerides.

In some embodiments, the edible coating composition can be melted or mixed with a solvent (e.g., water, ethanol, or the like) to form a coating mixture. The coating mixture can be coated onto an agricultural product. In some embodiments, the coating mixture is dried after coating the agricultural product. When the coating mixture is coated onto an agricultural product and dried to form a coating, the coating provides an increase in the mass loss factor of the agricultural product. For example, an agricultural product that is not coated by the coating mixture has a mass loss factor of 1, but an agricultural product that is coated by the coating mixture has a mass loss factor of at least 1.5, at least 1.55, at least 1.6, at least 1.7, at least 1.75, or at least 1.8. Advantageously, the coating provides the agricultural product with a higher mass loss factor than an agricultural product that is untreated.

As used herein, the term “mass loss rate” refers to the rate at which the product loses mass (e.g., by releasing water and other volatile compounds). The mass loss rate is typically expressed as a percentage of the original mass per unit time (e.g., percent per day).

As used herein, the term “mass loss factor” is defined as the ratio of the average mass loss rate of uncoated produce (measured for a control group) to the average mass loss rate of the corresponding tested produce (e.g., coated produce) over a given time. Hence a larger mass loss factor for a coated produce corresponds to a greater reduction in average mass loss rate for the coated produce. Unless otherwise defined herein, scientific and technical terms used in this application have the meanings that are commonly understood by those of ordinary skill in the art. In case of conflict, the present specification, including definitions, will control.

As used herein, “semi-solid” refers to a physical state which is neither solid nor liquid. A semi-solid is similar to a solid in some respects, e.g., a semi-solid can support its own weight and hold its shape, but also shares some properties of liquids, such as shape conformity to something applying pressure to it, or the ability to flow under pressure. Semi-solids are characterized by a three-dimensional structure that is sufficient to impart solid-like character to the undisturbed system but that is easily broken down and realigned under an applied force. Semi-solids have a rigidity and viscosity intermediate between a solid and a liquid.

As used herein, “room temperature” refers to a temperature in a range of about 20° C. to about 25° C. (e.g., about 22° C. to about 25° C.).

As used herein, average particle size refers to the average diameter or width of a plurality of the particles.

### Edible Coating Composition

In one aspect, the edible coating composition includes a multiplicity of particles, wherein each particle comprises a homogenous mixture of one or more monoglycerides and one or more fatty acid salts.

In some embodiments, the edible coating composition includes one or more monoglycerides. In some embodiments, the homogenous mixture includes one monoglyceride (e.g., a 1-monoglyceride or a 2-monoglyceride). In some embodiments, the homogenous mixture includes two monoglycerides (e.g., two 1-monoglycerides, two 2-monoglycerides, or one 1-monoglyceride and one 2-monoglyceride). In some embodiments, the homogenous mixture includes three monoglycerides. In some embodiments, the homogenous mixture includes four or more monoglycerides.

In some embodiments, one or more of the monoglycerides has a carbon chain length of about C10 to about C22. In some embodiments, the monoglyceride has a carbon chain length of about C10 to about C22. In some embodiments, the monoglyceride has a carbon chain length that comprises one or more of or is selected from the group consisting of a C10 monoglyceride, a C12 monoglyceride, a C14 monoglyceride, a C16 monoglyceride, a C18 monoglyceride, a C20 monoglyceride, and a C22 monoglyceride. In some embodiments, the monoglyceride is a saturated monoglyceride. In some embodiments, the saturated monoglyceride is monolaurin, glyceryl monostearate, glycerol monostearate, glyceryl monobehenate, glycerol monobehenate, or glyceryl hydroxystearate. In some embodiments, the monoglyceride is glyceryl monostearate. In some embodiments, the monoglyceride is glycerol monostearate. In some embodiments, the glyceryl monostearate is present in each particle in a molar ratio of at least 55:45 α-glyceryl monostearate to β-glyceryl monostearate, respectively. In some embodiments, the glyceryl monostearate is present in a molar ratio of at least 60:40, at least 65:35, at least 70:30, at least 75:25, or at least 80:20 of α-glyceryl monostearate to β-glyceryl monostearate. In some embodiments, the glyceryl monostearate is present in each particle in a molar ratio of at least 75:25 α-glyceryl monostearate to β-glyceryl monostearate. In some embodiments, the glyceryl monostearate is present in each particle in a molar ratio of about 80:20 α-glyceryl monostearate to β-glyceryl monostearate.

In some embodiments, the one or more monoglycerides is present in the homogenous mixture in an amount in a range of about 40 wt % to about 99 wt %, based on the total weight of the homogenous mixture. In some examples, the one or more monoglycerides is present in the homogenous mixture in an amount in a range of about 50 wt % to about 98 wt %, about 60 wt % to about 99 wt %, about 70 wt % to about 98 wt %, about 85 wt % to about 98 wt %, about 90 wt % to about 98 wt %, about 92 wt % to about 97 wt %, or about 95 wt %, based on the total weight of the homogenous mixture. In some embodiments, the one or more monoglycerides is present in the homogenous mixture in an amount in a range of about 75 wt % to about 98 wt %, based on the total weight of the homogenous mixture.

In some embodiments, the edible coating composition includes one or more fatty acid salts. In some embodiments, the homogenous mixture includes one fatty acid salt. In some embodiments, the homogenous mixture includes two fatty acid salts. In some embodiments, the homogenous mixture includes three fatty acid salts. In some embodiments, the homogenous mixture includes four or more fatty acid salts.

In some embodiments, at least one of the one or more fatty acid salts comprises a carbon chain length of about C10 to about C22. In some embodiments, each of the one or more fatty acid salts comprises a carbon chain length of about C10 to about C22. In some embodiments, at least one of the one or more fatty acid salts comprises a carbon chain length selected from the group of: C10, C12, C14, C16, C18, C20, or C22. In some embodiments, each of the one or more fatty acid salts comprises a carbon chain length selected from the group of: C10, C12, C14, C16, C18, C20, or C22. In some embodiments, the one or more fatty acid salts is a C14 fatty acid salt, C16 fatty acid salt, a C18 fatty acid salt, or a combination thereof. In some embodiments, the one or more fatty acid salts is a C16 fatty acid salt and a C18 fatty acid salt. In some embodiments, one or more of the fatty acid salts is saturated. In some embodiments, one or more of the fatty acid salts is unsaturated.

In some embodiments, one or more of the fatty acid salts is a salt of lauric acid, myristic acid, palmitic acid, stearic acid, arachidic acid, behenic acid, lignoceric acid, palmitoleic acid, caprylic acid, capric acid, cerotic acid, oleic acid, linoleic acid, arachidonic acid, eicosapentaenoic acid, docosahexaenoic acid, myristoleic acid, sapienic acid, elaidic acid, vaccenic acid, linoelaidic acid, α-linolenic acid, erucic acid, docosahexaenoic acid, or combinations thereof.

In some embodiments the fatty acid salt comprises one or more of or is selected from the group consisting of sodium laurate, myristate, sodium palmitate, sodium stearate, arachidic acid salt, sodium behenate, lignoceric acid sodium salt, sodium arachidonate, eicosapentaenoic acid sodium salt, docosahexaenoic acid sodium salt, sodium myristate, sapienate, elaidate, linoleic acid sodium salt, linoleic acid sodium salt, sodium erucate, and docosahexaenoic acid sodium salt.

In some embodiments, the one or more fatty acid salts is present in the homogenous mixture in an amount in a range of about 1 wt % to about 20 wt %, based on the total weight of the homogenous mixture. In some examples, the one or more fatty acid salts is present in the homogenous mixture in an amount in a range of about 1 wt % to about 10 wt %, about 1 wt % to about 8 wt %, 1 wt % to about 5 wt %, or about 1 wt % to about 3 wt %, based on the total weight of the homogenous mixture. In some embodiments, the one or more fatty acid salts is present in the homogenous mixture in an amount in a range of about 1 wt % to about 5 wt %, based on the total weight of the homogenous mixture.

In some embodiments, the homogenous mixture further comprises one or more emulsifiers. Emulsifiers, a type of surfactant or wetting agent, are excipients used for lowering the surface tension and for interaction with hydrophobic materials. In some embodiments, the emulsifier can be a phospholipid, a lysophospholipid, a glycoglycerolipid, a glycolipid (for example, sucrose esters of fatty acids), an ascorbyl ester of a fatty acid, an ester of lactic acid, an ester of tartaric acid, an ester of malic acid, an ester of fumaric acid, an ester of succinic acid, an ester of citric acid, an ester of pantothenic acid, or a fatty alcohol derivative (e.g. an alkyl sulfate). In some embodiments, the emulsifier is cationic. In some embodiments, the emulsifier is anionic. In some embodiments, the emulsifier is zwitterionic. In some embodiments, the emulsifier is uncharged. In some embodiments, the one or more emulsifiers are selected from the group of: sodium bicarbonate, citric acid, cetyl trimethylammonium bromide, sodium lauryl sulfate, ammonium lauryl sulfate, sodium laureth sulfate, sodium myreth sulfate, docusate, sodium dodecyl sulfate, sodium lauroyl sarcosinate, perfluorononanoate, perfluorooctanoate, perfluorooctanesulfonate (PFOS), perfluorobutanesulfonate, alkyl-aryl ether phosphates, alkyl ether phosphates, 2-[4-(2,4,4-trimethylpentan-2-yl)phenoxy]ethanol (Triton X-100), 3-[(3-cholamidopropyl)dimethylammonio]-1-propanesulfonate (CHAPS), cholic acid, nonyl phenoxypolyethoxylethanol (NP-40), octyl thioglucoside, octyl glucoside, dodecyl maltoside, octenidine dihydrochloride, cetrimonium bromide (CTAB), cetylpyridinium chloride (CPC), benzalkonium chloride (BAC), benzethonium chloride (BZT), dimethyldioctadecylammonium chloride, and dioctadecyldimethylammonium bromide (DODAB), cocamidopropyl hydroxysultaine, cocamidopropyl betaine, phosphatidylserine, phosphatidylethanolamine, phosphatidylcholine, phosphatidylinositol, phosphatidic acid, lysophosphatidylserine, lysophosphatidylethanolamine, lysophosphatidylcholine, lysophosphatidylinositol, lysophosphatidic acid, sphingomyelins, lauryldimethylamine oxide, myristamine oxide, octaethylene glycol monododecyl ether, pentaethylene glycol monododecyl ether, polyethoxylated tallow amine, cocamide monoethanolamine, or cocamide diethanolamine, poloxamers. In some examples, the one or more emulsifiers include sodium lauryl sulfate. In some examples, the one or more emulsifiers include sodium bicarbonate. In some examples, the one or more emulsifiers include citric acid.

In some embodiments, the one or more emulsifiers include one or more of lecithin, an ammonium phosphatide, and lysolecithin. In some embodiments, the one or more emulsifiers includes lecithin. In some embodiments, the one or more emulsifiers includes an ammonium phosphatide. In some embodiments, the one or more emulsifiers includes lysolecithin. In some embodiments, the one or more emulsifiers includes lecithin and lysolecithin. In some embodiments, the one or more emulsifiers includes lecithin, lysolecithin, and an ammonium phosphatide. In some embodiments, the one or more emulsifiers includes lysolecithin and an ammonium phosphatide. In some embodiments, the one or more emulsifiers includes lecithin and an ammonium phosphatide.

In some embodiments, the one or more emulsifiers are present in the homogenous mixture in an amount in a range of about 1 wt % to about 25 wt %, based on the total weight of the homogenous mixture. In some examples, the one or more emulsifiers are present in the homogenous mixture in an amount in a range of about 1 wt % to about 20 wt %, about 1 wt % to about 15 wt %, 1 wt % to about 12 wt %, about 1 wt % to about 10 wt %, or about 3 wt % to about 8 wt %, based on the total weight of the homogenous mixture. In some embodiments, the one or more emulsifiers are present in the homogenous mixture in an amount in a range of about 1 wt % to about 10 wt %, based on the total weight of the homogenous mixture.

In some embodiments, the homogenous mixture includes about 50 wt % to about 98 wt % of one or more monoglycerides; about 1 wt % to about 10 wt % of one or more fatty acid salts; and about 1 wt % to about 15 wt % of one or more emulsifiers.

In some examples, a homogenous mixture includes about 70 wt % to about 98 wt % of a C10 monoglyceride, a C12 monoglyceride, a C14 monoglyceride, a C16 monoglyceride, a C18 monoglyceride, a C20 monoglyceride, a C22 monoglyceride, or combinations thereof; and about 1 wt % to about 10 wt % of a C14 fatty acid salt, C16 fatty acid salt, a C18 fatty acid salt, or combinations thereof. In some embodiments, the homogenous mixture includes about 85 wt % to about 98 wt % of a C10 monoglyceride, a C12 monoglyceride, a C14 monoglyceride, a C16 monoglyceride, a C18 monoglyceride, a C20 monoglyceride, a C22 monoglyceride, or combinations thereof; and about 1 wt % to about 10 wt % of a C14 fatty acid salt, C16 fatty acid salt, a C18 fatty acid salt, or combinations thereof.

In some examples, a homogenous mixture includes about 70 wt % to about 98 wt % of a C10 monoglyceride, a C12 monoglyceride, a C14 monoglyceride, a C16 monoglyceride, a C18 monoglyceride, a C20 monoglyceride, a C22 monoglyceride, or combinations thereof; about 1 wt % to about 10 wt % of a C14 fatty acid salt, C16 fatty acid salt, a C18 fatty acid salt, or combinations thereof; and about 1 wt % to about 15 wt % of one or more emulsifiers.

In some embodiments, the one or more monoglycerides are saturated monoglycerides. In some embodiments, the saturated monoglycerides include one or more of monolaurin, glyceryl monostearate, glycerol monostearate, glyceryl monobehenate, glycerol monobehenate, and glyceryl hydroxystearate. In some embodiments, the one or more fatty acid salts are saturated fatty acid salts. In some embodiments, the saturated fatty acid salts include one or more of sodium laurate, sodium myristate, sodium palmitate, sodium stearate, and sodium behenate. In some embodiments, the one or more monoglycerides are saturated monoglycerides and the one or more fatty acid salts are saturated fatty acid salts.

In some embodiments, the homogenous mixture includes one or more of monolaurin, glyceryl monostearate, glycerol monostearate, glyceryl monobehenate, glycerol monobehenate, and glyceryl hydroxystearate; and one or more of sodium laurate, sodium myristate, sodium palmitate, sodium stearate, and sodium behenate. In some embodiments, the homogenous mixture includes one or more of monolaurin, glyceryl monostearate, glycerol monostearate, glyceryl hydroxystearate, glyceryl monobehenate, and glycerol monobehenate; one or more of sodium laurate, sodium myristate, sodium palmitate, sodium stearate, and sodium behenate; and a phosphate ester. In some embodiments, homogenous mixture includes one or more of monolaurin, glyceryl monostearate, glycerol monostearate, glyceryl monobehenate, glycerol monobehenate, and glyceryl hydroxystearate; one or more of sodium laurate, sodium myristate, sodium palmitate, sodium stearate, and sodium behenate; and one or more of lecithin, an ammonium phosphatide, and lysolecithin.

In some embodiments, the homogenous mixture includes about 80 wt % to about 98 wt % of one or more of monolaurin, glyceryl monostearate, glycerol monostearate, glyceryl monobehenate, glycerol monobehenate, and glyceryl hydroxystearate; about 1 wt % to about 10 wt % of one or more of sodium laurate, sodium myristate, sodium palmitate, sodium stearate, and sodium behenate. In some embodiments, the homogenous mixture includes about 80 wt % to about 98 wt % of one or more of monolaurin, glyceryl monostearate, glycerol monostearate, glyceryl monobehenate, glycerol monobehenate, and glyceryl hydroxystearate; about 1 wt % to about 10 wt % of one or more of sodium laurate, sodium myristate, sodium palmitate, sodium stearate, and sodium behenate; and optionally about 1 wt % to about 15 wt % emulsifiers. In some embodiments, the homogenous mixture includes about 80 wt % to about 98 wt % of one or more of monolaurin, glyceryl monostearate, glycerol monostearate, glyceryl hydroxystearate, glyceryl monobehenate, and glycerol monobehenate; about 1 wt % to about 10 wt % of one or more of sodium laurate, sodium myristate, sodium palmitate, sodium stearate, and sodium behenate; and about 1 wt % to about 15 wt % of one or more of citric acid, sodium bicarbonate, sodium lauryl sulfate, lecithin, an ammonium phosphatide, and lysolecithin. In some embodiments, the homogenous mixture includes about 80 wt % to about 98 wt % of one or more of monolaurin, glyceryl monostearate, glycerol monostearate, glyceryl monobehenate, glycerol monobehenate, and glyceryl hydroxystearate; about 1 wt % to about 10 wt % of one or more of sodium laurate, sodium myristate, sodium palmitate, sodium stearate, and sodium behenate; and about 1 wt % to about 15 wt % of a phosphate ester. In some embodiments, the homogenous mixture includes about 80 wt % to about 98 wt % one or more of monolaurin, glyceryl monostearate, glycerol monostearate, glyceryl monobehenate, glycerol monobehenate, and glyceryl hydroxystearate; about 1 wt % to about 10 wt % of one or more of sodium laurate, sodium myristate, sodium palmitate, sodium stearate, and sodium behenate; and about 1 wt % to about 15 wt % of one or more of lecithin, an ammonium phosphatide, and lysolecithin.

Coating mixtures including the edible coating compositions comprising a multiplicity of particles, wherein each particle comprises a homogenous mixture of monoglyceride(s) and fatty acid(s), and optionally emulsifiers, formed by melt-compounding or granulation, have been found to be effective at forming protective coatings over a variety of agricultural products that can prevent water loss from and oxidation of the agricultural products.

In some embodiments, less than 10% (e.g., less than 5%, less than 2%, less than 1%) by weight of the composition is diglycerides. In some embodiments, less than 10% (e.g., less than 5%, less than 2%, less than 1%) by weight of the composition is triglycerides. In some embodiments, the composition does not comprise an acetylated monoglyceride (e.g., a monoglyceride wherein the hydroxyl groups of the glyceryl moiety are acetylated).

In some embodiments, the edible coating composition is dissolved, mixed, dispersed, or suspended in a solvent to form a coating mixture. The coating mixture can be in the form of a solution, a suspension, or a colloid (e.g., an emulsion). Examples of solvents that can be used include water, methanol, ethanol, isopropanol, butanol, acetone, ethyl acetate, chloroform, acetonitrile, tetrahydrofuran, diethyl ether, methyl tert-butyl ether, or combinations thereof. In some examples, the solvent is water. In some examples, the solvent is ethanol.

In some embodiments, the concentration of the multiplicity of particles in the coating mixture is about 1 g/L to 200 g/L. In some examples, the concentration of the edible coating composition in the coating mixture is about 1 to 150 g/L, 1 to 100 g/L, 1 to 75 g/L, 1 to 150 g/L, 1 to 50 g/L, 1 to 25 g/L, 10 to 200 g/L, 10 to 150 g/L, 10 to 100 g/L, 10 to 75 g/L, 10 to 50 g/L, 10 to 45 g/L, 10 to 40 g/L, 25 to 75 g/L, 35 to 65 g/L, 40 to 60 g/L, 45 to 55 g/L, or 25 to 35 g/L.

In some embodiments, the edible coating composition includes a base. Examples of bases that can be used include NaOH, KOH, LiOH, NH₄OH NaHCO₃, KHCO₃, LiHCO₃, Na₂CO₃, K₂CO₃, and Li₂CO₃. In some examples, the base is NaOH. In some examples, the base is NaHCO₃.

In some embodiments, an inorganic salt (e.g., NaCl, KCl) can be included in the solvent (e.g., water) to aid mixing. In some embodiments, a total amount of inorganic salt in the solvent is at least 1 ppm, at least 3 ppm, at least 5 ppm, at least 10 ppm, at least 20 ppm, at least 30 ppm, at least 50 ppm, at least 100 ppm, at least 150, at least 200, at least 250 ppm, or at least 500 ppm. In some embodiments, a total amount of inorganic salt in the solvent is not more than 10 ppm, not more than 20 ppm, not more than 30 ppm, not more than 50 ppm, not more than 100 ppm, not more than 150, not more than 200, not more than 250 ppm, not more than 500 ppm, or not more than 1000 ppm.

In some embodiments, each particle is in the form of a flake, pastille, or the like. In some embodiments, each particle is in the form of a flake. In some embodiments, each particle is in the form of a pastille. The form of each particle of the multiplicity of particles can be controlled at least in part by the method of preparing the edible coating composition, e.g., the cooling rate of melt compounding mixture.

As described herein, the edible coating composition comprising the multiplicity of particles can be added to or dissolved, suspended, or dispersed in a solvent to form a colloid, suspension, or solution.

In some embodiments, the homogenous mixture or edible coating composition can further include one or more (e.g., 1, 2, or 3) preservatives. In some embodiments, the one or more preservatives comprise one or more antioxidants, one or more antimicrobial agents, one or more chelating agents, or any combination thereof. Exemplary preservatives include, but are not limited to, vitamin E, vitamin C, butylated hydroxyanisole (BHA), butylated hydroxytoluene (BHT), sodium benzoate, disodium ethylenediaminetetraacetic acid (EDTA), citric acid, benzyl alcohol, benzalkonium chloride, butyl paraben, chlorobutanol, meta cresol, chlorocresol, methyl paraben, phenyl ethyl alcohol, propyl paraben, phenol, benzonic acid, sorbic acid, methyl paraben, propyl paraben, bronidol, and propylene glycol.

In some embodiments, the homogenous mixture or edible coating composition includes about 0.1% to 40% by weight of the one or more preservatives. In some examples, the homogenous mixture or edible coating composition includes about 0.1% to 35%, 0.1% to 25%, 0.1% to 20%, 0.1% to 10%, 0.1% to 5%, 0.1% to 3%, 0.1% to 2%, 0.1% to 1%, or 0.1% to 0.5% by weight of the one or more preservatives.

The homogenous mixture that is combined with the solvent can include about 0.1% to 50% (e.g., about 0.1%-40%, 0.1%-25%, 0.1%-10%, 0.1%-5%, 1%-50%, 1%-25%, 1%-5%, or 1%-4%) by mass of a second group of compounds of fatty acids, fatty acid esters, fatty acid salts, or combinations thereof.

In some embodiments, any of the edible coating compositions described herein can further comprise one or more additives. In some embodiments, the additive comprises one or more of or is selected from the group consisting of a preservative, a stabilizer, a buffer, a vitamin, a mineral, a pH modifier, a salt, a pigment, a fragrance, an enzyme, a catalyst, an antioxidant, an antifungal, and an antimicrobial.

In some embodiments, the stabilizer is alginic acid, agar, carrageenan, pectin, or combinations thereof.

In some embodiments, the buffer is a citrate salt, a phosphate salt, a tartrate salt, or combinations thereof.

In some embodiments, the preservative is a nitrite derivative or salt thereof, a sulfite derivative or salt thereof, a benzoate derivative or salt thereof, or combinations thereof. In some embodiments, the preservative is butylated hydroxyanisole 320, butylated hydroxytoluene 321, or combinations thereof.

In some embodiments, the vitamin is vitamin A or derivatives thereof, vitamin B or derivatives thereof, vitamin C or derivatives thereof, vitamin D or derivatives thereof, vitamin E or derivatives thereof, or combinations thereof.

In some embodiments, the mineral is a macromineral, a trace mineral, or combinations thereof. In some embodiments, the mineral is iron, manganese, copper, iodine, zinc, cobalt, fluoride, selenium, or combinations thereof.

In some embodiments, the pigment is blue #1, blue #2, green #3, red #3, red #40, yellow #5, yellow #6, citrus red #2, corresponding aluminum lakes thereof, or combinations thereof.

In some embodiments, the enzyme is an enzyme preparation such as a decarboxylase, an aminopeptidase, an amylase, an asparaginase, a carboxypeptidase, a catalase, a cellulase, a chymosin, a cyprosin, a ficin, a glucanase, an isomerase, a glutaminase, an invertase, a lactase, a lipase, a lyase, a lysozyme, a mannase, an oxidase, a pectinase, a peptidase, a peroxidase, a phospholipase, a protease, a trypsin, a urease, or combinations thereof.

In some embodiments, the anti-oxidant is an anti-oxidant vitamin, a tocopherol, a gallate or derivative thereof, or combinations thereof. In some embodiments, the anti-oxidant is 4-hexylresorcinol ascorbic acid or a fatty acid esters thereof, sodium ascorbate, calcium ascorbate, citric acid, erythorbic acid, sodium erythorbate, tertiary-butyl hydroquinone, butylated hydroxyanisole, butylated hydroxytoluene, or combinations thereof.

In some embodiments, the compositions further comprise a pH modifier. In some embodiments, the pH modifier is an acid. In some embodiments, the pH modifier is a base. The pH modifier can include, for example, citric acid, acetic acid, hydrochloric acid, sulfuric acid, phosphoric acid, hydrobromic acid, ascorbic acid, tartaric acid, formic acid, gluconic acid, lactic acid, oxalic acid, boric acid, or a combination thereof.

In some embodiments, the compositions further comprise a food-safe antimicrobial. In some embodiments, the food-safe antimicrobial comprises one or more of or is selected from the group consisting of sodium benzoate, potassium sorbate, carvacrol, chalcone, fludioxonil, 2-hydroxychalcone, 4-hydroxychalcone, 4′-hydroxychalcone, 2,2′-dihydroxychalcone, 2,4′-dihydroxychalcone, 2′,4-dihydroxychalcone, 2′,4′-dihydroxychalcone, 2′,4,4′-trihydroxychalcone, 2′,4,4′-trihydroxychalcone intermediate, violastyrene, obtusaquinone, apiole, piperine, celastrol, eugenol, arthonoic acid, leoidin, antimycin A, antimycin A1, diffractaic acid, ethyl orsellinate, methyl orsellinate, mycophenolic acid, ethyl dichloroorsellinate, angolensin, isocotoin, eupatoriochromene, xanthoxylin, usnic acid, aloin, ononetin, apocynin, isopomiferin, deoxysappanone B7,4′-dimethyl ether, chrysin dimethyl ether, bergapten, gambogic acid, 2-hydroxyxanthone, isopimpinellin, xanthyletin, acetyl hymetochrome, nobiletin, hymechrome, methoxsalen, 4-methylesculetin, tangeritin, khellin, flavone, 3,4′,5,6,7-pentamethoxyflavone, deguelin(−), citropten, deoxysappanone B trimethyl ether, deoxysappanone B 7,3′-dimethyl ether, 2′,4′-dihydroxy-4-methoxychalcone, daunorubicin hydrochloride, plumbagin, menadione, thymoquinone, levomenthol, thymol, methyl trimethoxycinnamate, chavicol, cinnamylphenol, benzoate, napthoquinone, phenone, acetophenone, benzophenone, phenylacetophenone, salicylic acid, sodium salicylate, methyl salicylate, or chitosan. In some embodiments, the one or more food-safe antimicrobials is benzoate. In some embodiments, the one or more food-safe antimicrobials is sodium benzoate, potassium benzoate, or a combination thereof. In some embodiments, the one or more food-safe antimicrobials is sodium benzoate. In some embodiments, the one or more food-safe antimicrobials is chalcone. In some embodiments, the antifungal comprises one or more of or is selected from the group consisting of imidazole, epicatechin, methyl salicylate (MeSA), and combinations thereof.

In some embodiments, the edible coating composition can include an additive configured, for example, to modify the viscosity, vapor pressure, surface tension, or solubility of the coating. The additive can, for example, be configured to increase the chemical stability of the coating. For example, the additive can be an antioxidant configured to inhibit oxidation of the coating. In some embodiments, the additive can reduce or increase the melting temperature or the glass-transition temperature of the coating. In some embodiments, the additive is configured to reduce the diffusivity of water vapor, oxygen, CO₂, or ethylene through the coating or enable the coating to absorb more ultra-violet (UV) light, for example to protect the agricultural product (or any of the other products described herein). In some embodiments, the additive can be configured to provide an intentional odor, for example a fragrance (e.g., smell of flowers, fruits, plants, freshness, scents, etc.). In some embodiments, the additive can be configured to provide color and can include, for example, a dye or a US Food and Drug Administration (FDA) approved color additive.

Any of the homogenous mixtures or edible coating compositions formed thereof that are described herein can be flavorless or have high flavor thresholds, e.g., above 500 ppm by weight, and can be odorless or have a high odor threshold. In some embodiments, the materials included in any of the coatings described herein can be substantially transparent. For example, the homogenous mixture, the solvent, and/or any other additives included in the edible coating composition or coating composition can be selected so that they have substantially the same or similar indices of refraction. By matching their indices of refraction, they may be optically matched to reduce light scattering and improve light transmission. For example, by utilizing materials that have similar indices of refraction and have a clear, transparent property, a coating having substantially transparent characteristics can be formed.

The edible coating compositions described herein can be of high purity. For example, the compositions can be substantially free (e.g., be less than 10%, 5%, or 1% by weight) of diglycerides, triglycerides, acetylated monoglycerides, proteins, polysaccharides, phenols, lignans, aromatic acids, terpenoids, flavonoids, carotenoids, alkaloids, alcohols, alkanes, and/or aldehydes. In some embodiments, the compositions comprise less than 10% (e.g., less than 5% or 1%) by weight of diglycerides. In some embodiments, the compositions comprise less than 10% (e.g., less than 5% or 1%) by weight of triglycerides.

Advantageously, the total amount of monoglyceride in the edible coating composition does not degrade quickly over time at room temperature. For example, the total amount of monoglyceride in the edible coating composition is about ±3 wt % of the total amount of monoglyceride in the edible coating composition after the edible coating composition is kept for about 5 days at room temperature. In some embodiments, the total amount of monoglyceride in the edible coating composition is about ±2 wt % or ±1 wt % of the total amount of monoglyceride in the edible coating composition after the edible coating composition is kept for about 10 days at room temperature. In some embodiments, the total amount of monoglyceride in the edible coating composition is about ±3 wt % of the total amount of monoglyceride in the edible coating composition after the edible coating composition is kept for about 20 days at room temperature. In some embodiments, the total amount of monoglyceride in the edible coating composition is about ±3 wt % of the total amount of monoglyceride in the edible coating composition after the edible coating composition is kept for about 30 days at room temperature.

### Methods of Preparing the Edible Coating Composition

Provided herein are various methods of preparing an edible coating composition. In some embodiments, preparing the edible coating composition can include melt compounding. In some embodiments, one or more of the ingredients can be at least partially melted and then combined with the other ingredients. In some embodiments, two or more of the ingredients can be combined to yield a mixture, and then one or more of the ingredients in the mixture can be at least partially melted.

### First Method

A first method of preparing an edible coating composition includes: at least partially melting a material comprising one or more monoglycerides to yield a first mixture; combining the first mixture and one or more fatty acid salts to yield a second mixture; and cooling the second mixture to yield the edible coating composition, wherein the edible coating composition comprises a multiplicity of particles, each particle comprising a homogeneous mixture of the one or more monoglycerides and the one or more fatty acid salts. In some embodiments, cooling the second mixture comprises forming a multiplicity of particles comprising the homogeneous mixture. In some embodiments, preparing an edible coating composition includes: at least partially melting a material comprising one or more monoglycerides and optionally one or more emulsifiers to yield a first mixture; combining the first mixture and one or more fatty acid salts to yield a second mixture; and cooling the second mixture to yield the edible coating composition, wherein the edible coating composition comprises a multiplicity of particles, each particle comprising a homogeneous mixture of the one or more monoglycerides, the one or more fatty acid salts, and optionally the one or more emulsifiers.

At least partially melting the material of one or more monoglycerides can include heating the material. In some embodiments, the material is heated to a temperature of about 40° C. to about 100° C. In some embodiments, the material is heated to about 50° C. to about 100° C., about 60° C. to about 100° C., or about 60° C. to about 90° C. about, or about 70° C. to about 100° C. In some embodiments, the material is heated to a temperature of about 70° C. to about 100° C. In some embodiments, the material is heated for a length of time in a range of about 15 minutes to about 6 hours, or about 15 minutes to about 3 hours.

In some embodiments, the first method further comprises mixing the second mixture for a length of time (e.g., about 15 minutes to about 1 hour, or about 15 minutes to 30 minutes, or less than 1 hour, or less than 30 minutes).

In some embodiments, the second mixture is cooled to room temperature or less. In some embodiments, the second mixture is cooled to a temperature of less than 25° C. In some embodiments, the second mixture is cooled to a temperature of less than 15° C. In some embodiments, the second mixture is cooled at a rate of about 1° C./minute to about 15° C./minute, about 2° C./minute to about 10° C./minute, or about 2° C./minute to about 15° C./minute, or about 2° C./minute, about 3° C./minute, about 4° C./minute, or about 5° C./minute. In some embodiments, the first method comprises cooling the second mixture to yield the edible coating composition, wherein the edible coating composition comprises a homogenous mixture of the one or more monoglycerides and the one or more fatty acid salts. In embodiments, the homogenous mixture comprises a multiplicity of particles, wherein each particle is in the form of a solid. In some embodiments, the edible coating composition is in the form of a solid. In some embodiments, the homogenous mixture is in the form of flakes, droplets, or pastilles.

In some embodiments, cooling the second mixture comprises extruding the second mixture. In some embodiments, the extruding occurs in a single screw-extruder or a twin-screw extruder. In some embodiments, the extruding comprises heating the second mixture to a temperature in a range of about 40° C. to about 100° C., about 50° C. to about 100° C., about 60° C. to about 100° C., about 60° C. to about 90° C. about, or about 70° C. to about 100° C., followed by cooling the second mixture. In some embodiments, after extruding, the second mixture is in the form of compressed aggregates, a mixture of liquid and solid, or a mixture of liquid and semi-solid. In some embodiments, after extruding, the second mixture is in the form of a liquid melt.

In some embodiments, cooling the second mixture comprises cooling to a temperature in a range of about 0° C. to about 20° C. In some embodiments, cooling the second mixture comprises directly or indirectly contacting the second mixture with a surface (e.g., a conveyor belt, a roller, or both), at a temperature in a range of about 0° C. to about 20° C.

### Second Method

A second method of preparing an edible coating composition can include: combining one or more monoglycerides and one or more fatty acid salts to yield a mixture; heating the mixture to at least partially melt the one or more monoglycerides; mixing the mixture to at least partially melt the one or more fatty acid salts; and cooling the mixture to yield the edible coating composition, wherein the edible coating composition comprises a multiplicity of particles, each particle comprising a homogeneous mixture of the one or more monoglycerides and the one or more fatty acid salts. In some embodiments, the method of preparing an edible coating composition can include: combining one or more monoglycerides, one or more fatty acid salts, and optionally one or more emulsifiers to yield a mixture; heating the mixture to at least partially melt the one or more monoglycerides; mixing the mixture to at least partially melt the one or more fatty acid salts; and cooling the mixture to yield the edible coating composition, wherein the edible coating composition comprises a multiplicity of particles, each particle comprising a homogeneous mixture of the one or more monoglycerides, the one or more fatty acid salts, and optionally the one or more emulsifiers.

In some embodiments, heating the mixture to at least partially melt the one or more monoglycerides comprises heating the mixture to a temperature of about 40° C. to about 100° C. In some embodiments, the mixture is heated to about 50° C. to about 100° C., about 60° C. to about 100° C., about 60° C. to about 90° C., or about 70° C. to about 100° C. In some embodiments, the mixture is heated to a temperature of about 70° C. to about 100° C. In some embodiments, the mixture is heated for a length of time in a range of about 15 minutes to about 6 hours, or about 15 minutes to about 3 hours.

In some embodiments, the second method comprises mixing the mixture to at least partially melt the one or more fatty acid salts (e.g., wherein the fatty acid salts dissolve in the already melted one or more monoglycerides). In some embodiments, the second method comprises processing the mixture in the reservoir for a length of time (e.g., about 15 minutes to about 1 hour, or about 15 minutes to 30 minutes, or less than 1 hour, or less than 30 minutes).

In some embodiments, the mixture is cooled to room temperature or less. In some embodiments, the mixture is cooled to a temperature of less than 25° C. In some embodiments, the mixture is cooled to a temperature of less than 15° C. In some embodiments, the mixture is cooled at a rate of about 1° C./minute to about 15° C./minute, about 2° C./minute to about 10° C./minute, about 2° C./minute to about 15° C./minute, about 2° C./minute, about 3° C./minute, about 4° C./minute, or about 5° C./minute. In some embodiments, the second method comprises cooling the mixture to yield the edible coating composition, wherein the edible coating composition comprises a multiplicity of particles, each particle comprising a homogenous mixture of the one or more monoglycerides and the one or more fatty acid salts. In some embodiments, the homogenous mixture is in the form of a solid. In some embodiments, the homogenous mixture comprises a multiplicity of particles, wherein each particle is in the form of a solid. In some embodiments, the homogenous mixture is in the form of flakes, droplets, or pastilles.

In some embodiments, cooling the mixture comprises extruding the mixture. In some embodiments, the extruding occurs in a single screw-extruder or a twin-screw extruder. In some embodiments, the extruding comprises heating the second mixture to a temperature in a range of about 40° C. to about 100° C., about 50° C. to about 100° C., about 60° C. to about 100° C., about 60° C. to about 90° C. about, or about 70° C. to about 100° C., followed by cooling the mixture. In some embodiments, after extruding, the mixture is in the form of compressed aggregates, a mixture of liquid and solid, or a mixture of liquid and semi-solid. In some embodiments, after extruding, the mixture is in the form of a liquid melt.

In some embodiments, cooling the mixture comprises cooling to a temperature in a range of about 0° C. to about 20° C. In some embodiments, cooling the mixture comprises contacting the mixture with a surface (e.g., a conveyor belt, a roller, or both), at a temperature in a range of about 0° C. to about 20° C.

In some embodiments, it has been advantageously found that in either the first method or the second method, when the temperature of heating the mixture is about 80° C. or less or about 70° C. to about 80° C., the total amount of one or more monoglycerides in the edible coating composition does not decrease quickly. For example, the total amount of one or more monoglycerides in the edible coating composition prepared by either the first method or the second method is about ±3 wt % of the total amount of one or more monoglycerides in the edible coating composition after the edible coating composition is heated for about 200 minutes, or at least 200 minutes. In some embodiments, it has been advantageously found that in either the first method or the second method, when the total amount of one or more fatty acids in the mixture is 5 wt % or less, then the total amount of one or more monoglycerides is about ±3 wt % of the initial amount of monoglyceride after heating the edible coating composition to a temperature of about 80° C. or less or about 70° C. to about 80° C. for 200 minutes, or at least 200 minutes.

### Third Method

A third method of preparing an edible coating composition comprises: combining one or more particulate monoglycerides and one or more particulate fatty acid salts to yield a mixture comprising a multiplicity of particles; and granulating the mixture to yield the edible coating composition. In some embodiments, methods of preparing an edible coating composition comprise: combining one or more particulate monoglycerides, one or more particulate fatty acid salts, and optionally one or more particulate emulsifiers to yield a mixture comprising a multiplicity of particles; and granulating the mixture to yield the edible coating composition. In some embodiments, granulating the mixture comprises dry granulation, fluidized bed granulation, or high shear granulation. In some embodiments, granulating the mixture comprises dry granulation. In some embodiments, granulating the mixture comprises dry granulation to yield the edible coating composition, and the edible coating composition comprises particles that can be compacted with a force in a range of about 2000 pounds to about 5000 pounds to yield an aggregate. In some embodiments, the multiplicity of particles is in the form of a powder, a semi-solid, a wax, a pellet, or a combination thereof. In some embodiments, the edible coating composition has a bulk density that exceeds the bulk density of the multiplicity of particles prior to granulation. In some embodiments, the edible coating composition has a particle size that exceeds the particle size of the multiplicity of particles prior to granulation. In some embodiments, the edible coating composition has a flowability with a Hausner Ratio of 1 to 1.34. In some embodiments, the edible coating composition has a flowability with a Carr Index of less than 25.

In some embodiments, the third method further comprises milling and sieving the edible coating composition. In some embodiments, the edible coating composition is milled and sieved to a particle size of about 800 microns to about 1500 microns, about 840 microns to about 1410 microns, about 800 microns to about 1000 microns, or about 1050 microns to about 1450 microns. In some embodiments, the particle size is about 840 microns to about 1410 microns.

In some embodiments, the third method further comprises contacting a liquid binder with the mixture during the granulating. In some embodiments, the liquid binder comprises one or more of water, gelatin, guar gum, sucrose, corn starch, casein, xanthan gum, locust bean gum, agar, and carrageenan. In some embodiments, the method further comprises combining water with the mixture at a temperature greater than room temperature (e.g., about 50° C. to about 100° C.) prior to contacting the liquid binder with the mixture.

In some embodiments, the third method further comprises drying the edible coating composition. In some embodiments, drying the edible coating composition occurs in a fluidized bed.

In some embodiments, the third method further comprises granulating each of the one or more particulate monoglycerides and one or more particulate fatty acid salts. In some embodiments, the third method further comprises granulating each of the one or more particulate monoglycerides, one or more particulate fatty acid salts, and optionally one or more particulate emulsifiers prior to combining each of the one or more particulate monoglycerides, one or more particulate fatty acid salts, and optionally one or more particulate emulsifiers.

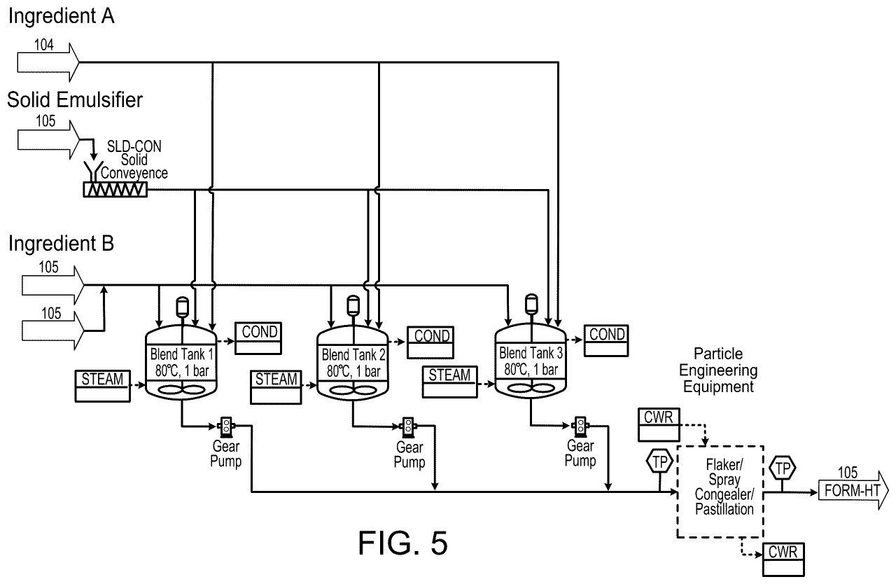

FIG. 5 is an example of a melt compounding system for the edible coating compositions disclosed herein, wherein ingredient A is one or more monoglycerides, ingredient B is one or more fatty acids, and the emulsifier is in the solid state. In one example, the one or more monoglycerides, the one or more fatty acids, and the emulsifier are combined in a reservoir that is heated to 80° C. and has a pressure of 1 bar for a length of time to form an at least partially melted mixture. The at least partially melted mixture is then pumped into a commercial flaker, spray congealer, or pastillation station.

### Methods of Preparing a Coating Mixture

Provided herein are methods of preparing a coating mixture. Preparing a coating mixture can comprise combining a crystalline form of the edible coating composition disclosed herein and water to form the coating mixture. In some embodiments, the coating mixture comprises about 1 wt % to about 30 wt % water, about 1 wt % to about 20 wt % water, about 1 wt % to about 18 wt % water, or about 5 wt % to about 15 wt % water. In some embodiments, the coating mixture comprises about 1 wt % to about 20 wt % water.

Advantageously, the total amount of monoglyceride in the coating mixture does not decrease quickly over time at room temperature. In some embodiments, the total amount of monoglyceride in the coating mixture is about ±3 wt %, ±2 wt %, or ±1 wt %, of the total amount of monoglyceride in the coating mixture after the coating mixture is let sit for about 24 hours, 48 hours, 72 hours, 7 days, 10 days, 20 days, or 30 days at room temperature. In some embodiments, the total amount of monoglyceride in the coating mixture is about ±3 wt % of the total amount of monoglyceride in the coating mixture after the coating mixture is let sit for about 24 hours at room temperature. the total amount of monoglyceride in the coating mixture is about ±3 wt % of the total amount of monoglyceride in the coating mixture after the coating mixture is let sit for about 72 hours at room temperature. In some embodiments, the total amount of monoglyceride in the coating mixture is about ±3 wt % of the total amount of monoglyceride in the coating mixture after the coating mixture is let sit for about 7 days at room temperature. In some embodiments, the coating mixture has a turbidity of less than 2000 nephelometric turbidity unit (“NTU”) less than 1800 NTU, less than 1500 NTU, or greater than 500 NTU. In some embodiments, the coating mixture has a turbidity of less than 2000 NTU. In some embodiments, the coating mixture has a turbidity in a range of 500 NTU to 2000 NTU, 750 NTU to 1800 NTU, or 1000 NTU to 1500 NTU.

In some embodiments, the method of preparing the coating mixture further comprises coating an agricultural product with the coating mixture to yield a coated agricultural product.

During the handling of powder, dust can be generated. The dust can be hazardous to the operators and pollute the direct environment of the operators. Further, when powders of various ingredients are blended and/or packaged, segregation of the various ingredients can occur during manufacture and/or the supply chain thereby modifying the intended ratio of ingredients in the formulation and impacting the performance of the final product. Advantageously, the method of preparing the edible coating composition including granulation modifies the particle size distribution and bulk density of the ingredients, having one or more of the following impacts: improving flowability, mitigating dust formation, limiting ingredients sticking to surfaces, and reducing uncontrolled loss of ingredients during transport and handling. The granulation can allow the edible coating compositions to be accurately and precisely measured for a more consistent end product. Further, the changes to one or more of the shape, size, surface of the particles, and the like can help stabilize the compounds that are sensitive to environmental factors, e.g., temperature and humidity.

### Coated Agricultural Product

In one aspect, the edible coating composition when combined with a solvent to form the coating mixture can be coated onto an agricultural product. Any of the edible coating compositions described herein or when combined with a solvent to form the coating mixture can be disposed on the external surface of an agricultural product using any suitable means. For example, the agricultural product can be dip-coated in a bath of the coating mixture. The deposited coating mixture can form a thin layer on the surface of an agricultural product, which can protect the agricultural product from biotic stressors, water loss, respiration, and/or oxidation. In some embodiments, the deposited coating can have a thickness of less than 20 microns, less than 10 microns, less than 5 microns, about 100 nm to about 20 microns, about 100 nm to about 2 microns, about 700 nm to about 1 micron, about 1 micron to about 1.6 microns, or about 1.2 microns to about 1.5 microns.

In some embodiments, the deposited coating mixture can be deposited substantially uniformly over the agricultural product and can be free of defects and/or pinholes. In some embodiments, the dip-coating process can include sequential coating of the agricultural product in baths of coating precursors (e.g., the edible coating composition) that can undergo self-assembly or covalent bonding on the agricultural product to form the deposited coating mixture. In some embodiments, the coating mixture can be deposited on agricultural products by passing the agricultural products under a stream of the coating mixture (e.g., a waterfall of the coating mixture). For example, the agricultural products can be positioned on a conveyor that passes through the stream of the coating mixture. In some embodiments, the coating mixture can be misted, vapor- or dry vapor-deposited on the surface of the agricultural product. In some embodiments, the coating mixture can be mechanically applied to the surface of the agricultural product to be coated, for example by brushing it onto the surface. In some embodiments, the coating can be configured to be fixed on the surface of the agricultural product by UV crosslinking or by exposure to a reactive gas, for example oxygen.

In some embodiments, the coating mixture can be spray-coated on the agricultural products. Commercially available sprayers can be used for spraying the coating mixture onto the agricultural product. In some embodiments, the coating mixture can be electrically charged in the sprayer before spray-coating on to the agricultural product, such that the deposited coating mixture electrostatically and/or covalently bonds to the exterior surface of the agricultural product.

The edible coating compositions formed from homogenous mixtures described herein included in the coating mixture can be configured to prevent water loss or other moisture loss from the coated portion of an agricultural product, delay ripening, prevent oxygen diffusion into the coated portion of the agricultural product, or combinations thereof, for example, to reduce oxidation of the coated portion of the agricultural product. The coating mixture can also serve as a barrier to diffusion of carbon dioxide and/or ethylene into or out of the agricultural product. The coating mixture can also protect the coated portion of the agricultural product against biotic stressors, such as, for example, bacteria, fungi, viruses, and/or pests that can infest and decompose the coated portion of the agricultural product. Since bacteria, fungi, and pests all identify food sources via recognition of specific molecules on the surface of the agricultural product, coating the agricultural products with the coating mixture can deposit molecularly contrasting molecules on the surface of the portion of the agricultural product. Furthermore, the coating mixture can also alter the physical and/or chemical environment of the surface of the agricultural product making the surface unfavorable for bacteria, fungi or pests to grow. The coatings can also be formulated to protect the surface of the portion of the agricultural product from abrasion, bruising, or other mechanical damage, and protect the portion of the agricultural product from photodegradation.

Any of the edible coating compositions described herein or coating mixtures thereof can be used to reduce the humidity generated by the agricultural product (e.g., fresh produce) via mass loss (e.g., water loss) during transportation and storage by reducing the mass loss rate of the agricultural product (e.g., fresh produce).

In some embodiments, the agricultural product is coated with an edible coating composition thereof that reduces the mass loss rate by at least 10%, 20%, 30%, 40%, 45%, 50%, 55%, 60%, 65%, 70%, 80%, 90%, or greater compared to untreated agricultural product measured. In some embodiments, treating an agricultural product using any of the coatings described herein can give a mass loss factor of at least 1.1, at least 1.2, at least 1.3, at least 1.4, at least 1.5, at least 1.6, at least 1.7, at least 1.8, at least 1.9, at least 2.0, at least 2.2, at least 2.4, at least 2.6, at least 2.8, or at least 3.0. In some embodiments, treating an agricultural product using the coating mixture disclosed herein can reduce the humidity generated during storage by at least 1%, 5%, 10%, 20%, 30%, 40%, 50%, 60%, 70%, 80%, 90%, or greater compared to untreated product. In some embodiments, the reduction in mass loss rate of the agricultural product can reduce the energy required to maintain a relative humidity at a predetermined level (e.g., at 90% relative humidity or less, at 85% relative humidity or less, at 80% relative humidity or less, at 75% relative humidity or less, at 70% relative humidity or less, at 65% relative humidity or less, at 60% relative humidity or less, at 55% relative humidity or less, at 50% relative humidity or less, or at 45% relative humidity or less) during storage or transportation. In some embodiments, the energy required to maintain a relative humidity at the predetermined level (e.g., any of the predetermined levels listed above) during storage or transportation can be reduced by at least 1%, 5%, 10%, 20%, 30%, 40%, 50%, 60%, 70%, 80%, 90%, or greater compared to untreated product.

Any of the edible coating compositions described herein or coating mixtures thereof can be used to reduce the heat generated by agricultural products (e.g., fresh produce) via respiration during transportation and storage by reducing the respiration rate of the agricultural products (e.g., fresh produce). In some embodiments, the agricultural product is coated with an edible coating composition that reduces the respiration rate by at least 10%, 20%, 30%, 40%, 50%, 60%, 70%, 80%, 90%, or greater compared to untreated agricultural product (measured as described above). In some embodiments, the reduction in heat generated by the agricultural product can reduce the energy required to maintain a temperature (e.g., a predetermined temperature) during storage or transportation. In some embodiments, the heat generated can be reduced by at least 5%, 10%, 20%, 30%, 40%, 50%, 60%, 70%, 80%, 90%, or greater for coated products compared to untreated products. In some embodiments, the energy required to maintain the coated products at a predetermined temperature (e.g., at 25° C. or less, at 23° C. or less, at 20° C. or less, at 18° C. or less, at 15° C. or less, at 13° C. or less, at 10° C. or less, at 8° C. or less, at 5° C. or less, or at 3° C. or less) can be reduced by at least 1%, 5%, 10%, 20%, 30%, 40%, 50%, 60%, 70%, 80%, 90%, or greater compared to untreated products.

Any of the edible coating compositions described herein can be used to protect a variety of agricultural products. In some embodiments, the edible coating composition can be coated on an edible agricultural product, for example, fruits, vegetables, edible seeds and nuts, herbs, spices, produce, meat, eggs, dairy products, seafood, grains, or any other consumable item. In such embodiments, the edible coating composition can include components that are non-toxic and safe for consumption by humans and/or animals. For example, the coating can include components that are U.S. Food and Drug Administration (FDA) approved direct or indirect food additives, FDA approved food contact substances, satisfy FDA regulatory requirements to be used as a food additive or food contact substance, and/or is an FDA Generally Recognized as Safe (GRAS) material. Examples of such materials can be found within the FDA Code of

Federal Regulations Title 21, located at “www.accessdata.fda.gov/scripts/cdrh/cfdocs/cfcfr/cfrsearch.cfm”, the entire contents of which are hereby incorporated by reference herein. In some embodiments, the components of the coating can include a dietary supplement or ingredient of a dietary supplement. The components of the coating can also include an FDA approved food additive or color additive. In some embodiments, the coating can include components that are naturally derived, as described herein. In some embodiments, the coating can be configured to be washed off an edible agricultural product, for example, with water.

Accordingly, the materials of this disclosure can be hydrophobic, hydrophilic, lipophilic, lipophobic, omniphobic, gas impermeable, grease impermeable, oil impermeable, gas resistant, grease resistant, oil resistant, or any appropriate combination thereof. The hydrophilicity, hydrophobicity, lipophobicity, and lipophobicity of the material according to this disclosure can be measured according to methods known to those skilled in the art (e.g., by measuring the contact angle of the material on an agricultural product, such as the surface of an agricultural product, with a goniometer).

As used herein, the term “contact angle” of a liquid on a solid surface refers to an angle of the outer surface of a droplet of the liquid measured where the liquid-vapor interface meets the liquid-solid interface.

### Methods of Use and Application

Provided herein are methods of coating an agricultural product. The methods include applying the coating mixture to a surface of an agricultural product, and drying the coating mixture on the surface of the agricultural product to form a coated agricultural product. In some embodiments, drying the coating mixture includes contacting the coated agricultural product with a forced flow of air at a temperature greater than room temperature.

In some embodiments, the temperature of coating mixture while applying to a surface of an agricultural product is between 10° C. and 80° C. For example, the temperature of coating mixture is between 10° C. and 70° C., between 20° C. and 80° C., between 20° C. and 60° C., between 20° C. and 30° C., or between 40° C. and 70° C. In some embodiments, the temperature of the coating mixture is between 10° C. and 30° C., or ambient temperature (e.g., a room temperature of a packing house).

In some embodiments, the temperature of the forced air while drying the coating mixture is between 20° C. and 120° C. For example, the temperature of the air is between 20° C. and 100° C., between 40° C. and 120° C., or between 50° C. and 100° C. In some embodiments, the temperature of the air is between 60° C. and 80° C., between 65° C. and 75° C., or about 70° C.

In some embodiments, coating mixture can be dried for a length of time of about 10 minutes to about 120 minutes, about 30 minutes to about 100 minutes, or about 40 minutes or about 80 minutes.

The coating mixture can be disposed on the external surface of an agricultural product (e.g., a cuticular surface) using any suitable means. The coating mixture can form a thin layer on the surface of the agricultural product, which can protect the agricultural product from biotic stressors, water loss, and/or oxidation.

In some embodiments, the coating mixture can be spray coated on the agricultural product. In some embodiments, applying coating mixture to the surface of the agricultural product comprises spraying the coating mixture onto the surface of the agricultural product. Commercially available sprayers can be used for spraying the edible coating composition onto the surface of the agricultural product.

In some embodiments, the coating mixture can be deposited on an agricultural product by passing the agricultural products under a stream of the coating mixture (e.g., a waterfall of the coating mixture). For example, the agricultural product can be disposed on a conveyor that passes through the stream of the coating mixture. In some embodiments, the coating mixture can be vapor deposited on the surface of the agricultural product. In some embodiments, the coating mixture can be applied in the field before harvest. In some embodiments, the coating mixture is applied to the agricultural product pre-harvest. In some embodiments, the coating mixture can be applied to the agricultural product after harvest (e.g., after the agricultural product has been detached or separated from where the majority of growth has taken place). In some embodiments, the coating mixture is applied to the agricultural product post-harvest.

In some embodiments, the agricultural product can be plant matter such as a flower or produce (e.g., fresh produce). In some embodiments, the agricultural product comprises one or more of or is selected from the group consisting of a fruit, a vegetable, a leaf, a stem, bark, a seed, a flower, and a combination thereof. In some embodiments, the agricultural product is a flower. In some embodiments, the agricultural product is fresh produce. In some embodiments, the agricultural product is a vegetable. In some embodiments, the agricultural product is a fruit.

In some embodiments, following the application of the coating mixture to the agricultural product desiccation is reduced. In some embodiments, following application of the coating mixture the rate of water lost from the agricultural product is reduced. In some embodiments, desiccation is measured with mass loss. In some embodiments, following the application of the coating mixture the rate of mass loss is reduced. In some embodiments, water loss is measured by mass loss. Mass loss, for example, can be measured by determining the difference between the weight of agricultural product after application of the coating mixture and after a certain period of time passes. In some embodiments, mass loss is measured after 1 day, 2 days, 3 days, 4 days, 5 days, 6 days, 7, days, 8 days, 9 days, and/or 10 days or after any combination thereof. In some embodiments, mass loss is measured after 1 week, after 2 weeks, after 3 weeks, after 4 weeks, after 5 weeks, after 6 weeks, after 7 weeks, after 8 weeks, after 9 weeks, after 10 weeks, after 11 weeks, after 12 weeks, or after any combination thereof.

In some embodiments, following application of the coating mixture the respiration rate of the agricultural product is reduced. For example, the application of any of the coating mixture can be used to block or limit diffusion of gasses such as ethylene, CO₂, and O₂, among others, thereby slowing ripening and/or senescence. In some embodiments, following the application of the coating mixture, the rate of CO₂ production by the agricultural product is reduced.

The foregoing description and following examples detail certain specific embodiments of the disclosure and describe the best mode that the inventors contemplated. It will be appreciated, however, that no matter how detailed the foregoing may appear in text, the disclosure may be practiced in many ways, and the disclosure should be construed in accordance with the appended claims and equivalents thereof.

Although the disclosed teachings have been described with reference to various applications, methods, compounds, compositions, and materials, it will be appreciated that various changes and modifications to them may be made without departing from the teachings herein. The following examples are provided to better illustrate the disclosed teachings and are not intended to limit the scope of the teachings presented herein. While the present teachings have been described in terms of these exemplary embodiments, the skilled artisan will readily understand that numerous variations and modifications of these exemplary embodiments are possible without undue experimentation. All such variations and modifications are within the scope of the teachings of this disclosure.

### EXAMPLES

The following examples describe effects of various coating mixtures on various agricultural products, as well as characterization of some of the edible coating compositions and coating mixtures. These examples are only for illustrative purposes and are not meant to limit the scope of the present disclosure. In each of the examples below, all reagents and solvents were purchased and used without further purification unless specified.

### Materials and Methods

The materials and methods of the disclosure will be further described in the following examples, which do not limit the scope of the methods and compositions of matter described in the claims. Glycerol monostearate is a thermodynamic mixture obtained from commercial sources generally having a molar ratio of 1-glycerol monostearate to 2-glycerol monostearate of about 9:1.

### Example 1: Polymorphs of Glycerol Monostearate

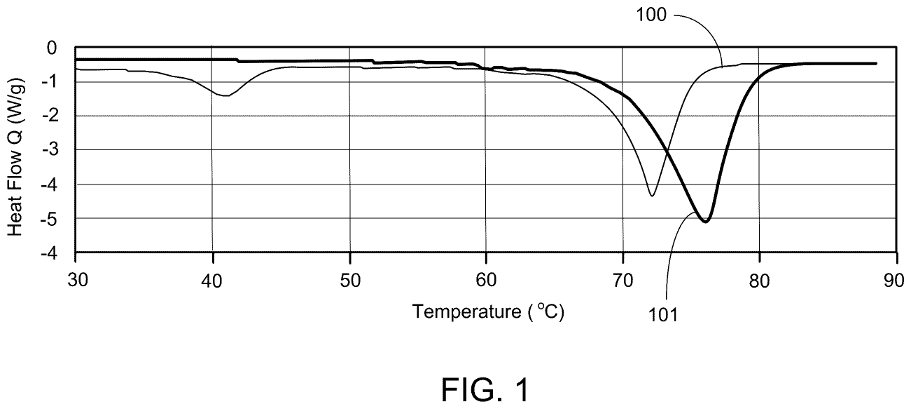

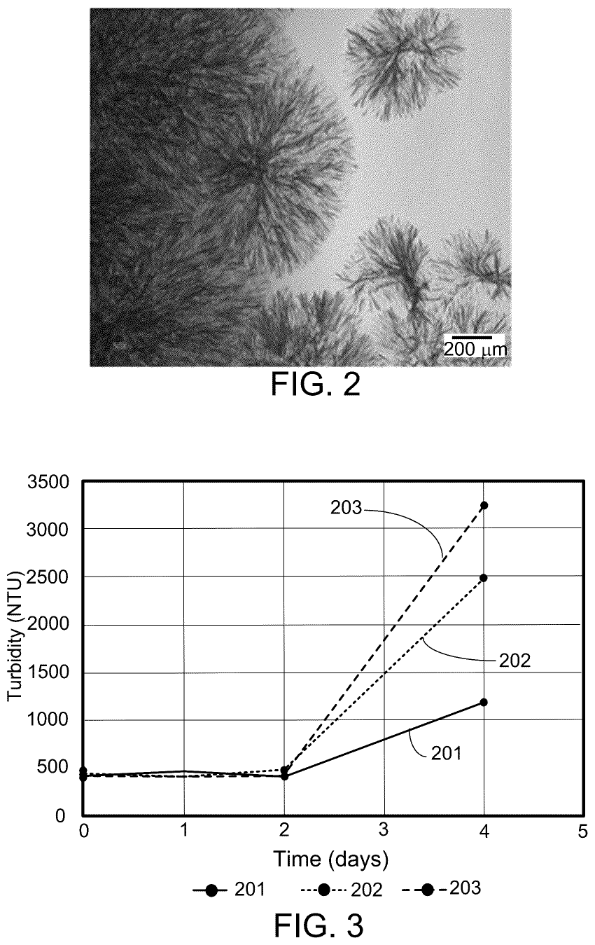

Two polymorphs of glycerol monostearate, α-glycerol monostearate polymorph and β-glycerol monostearate, were characterized by differential scanning calorimetry (DSC). The DSC curves of α-glycerol monostearate polymorph and β-glycerol monostearate polymorph are shown in FIG. 1 as plots 100 and 101, respectively. The β-glycerol monostearate was obtained from commercial sources and the α-glycerol monostearate was obtained through melt compounding as follows. The α-glycerol monostearate was obtained by heating β-glycerol monostearate at a temperature of 90° C. for about 45 minutes. The glycerol monostearate was then cooled to a temperature of 25° C. at a cooling rate of 10° C./min to form the α-glycerol monostearate. FIG. 2 is an optical micrograph photographic image of the α-glycerol monostearate.

Two different compositions were prepared from the α-glycerol monostearate and the β-glycerol monostearate. Sample 1 (“S1”) was prepared by mixing 6 wt % sodium stearate and 94 wt % glycerol monostearate, wherein the glycerol monostearate included about 80 wt % α-glycerol monostearate and 20 wt % β-glycerol monostearate based on the total weight of glycerol monostearate. Sample 2 (“S2”) was prepared by mixing 6 wt % sodium stearate and 94 wt % glycerol monostearate, wherein the glycerol monostearate included 100 wt % β-glycerol monostearate based on the total weight of the glycerol monostearate. The turbidity of the two samples was assessed over a four day time period at various temperatures. S2 was held at a temperature greater than 65° C. for four days. The turbidity of S2 is shown in FIG. 3 as plot 203. A first portion of S1 was held at room temperature for four days. The turbidity of the first portion of S1 is shown in FIG. 3 as plot 202. A second portion of S1 was held at a temperature greater than 65° C. for four days. The turbidity of the second portion of S1 is shown in FIG. 3 as plot 201. As the graph shows, the α-glycerol monostearate has lower turbidity for a longer time, and therefore has better stability.

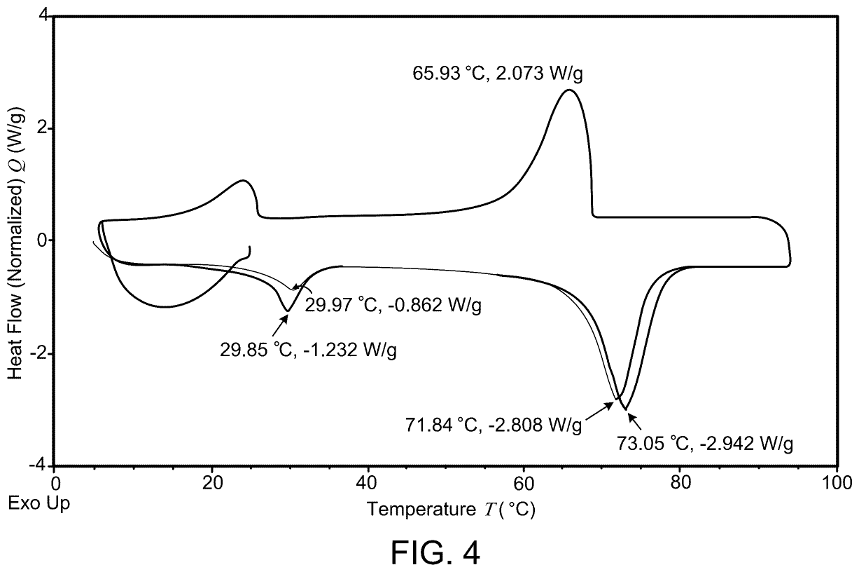

FIG. 4 shows a DSC curve of glycerol monostearate melt compounded with sodium stearate. β-glycerol monostearate powder was combined with sodium stearate powder in a round bottom flask and heated to a temperature in a range of 90° C. to 100° C. for about 30 minutes to about 60 minutes to form a melted mixture. The melted mixture was then cooled in a room temperature baking sheet. The baking sheet with the melted mixture was then placed in a −20° C. freezer until the melted mixture was a brittle solid. The brittle solid included 80% α-glycerol monostearate and 20% β-glycerol monostearate based on the total weight of the glycerol monostearate.

### Example 2: Stability of Edible Coating Composition From Melt Compounding

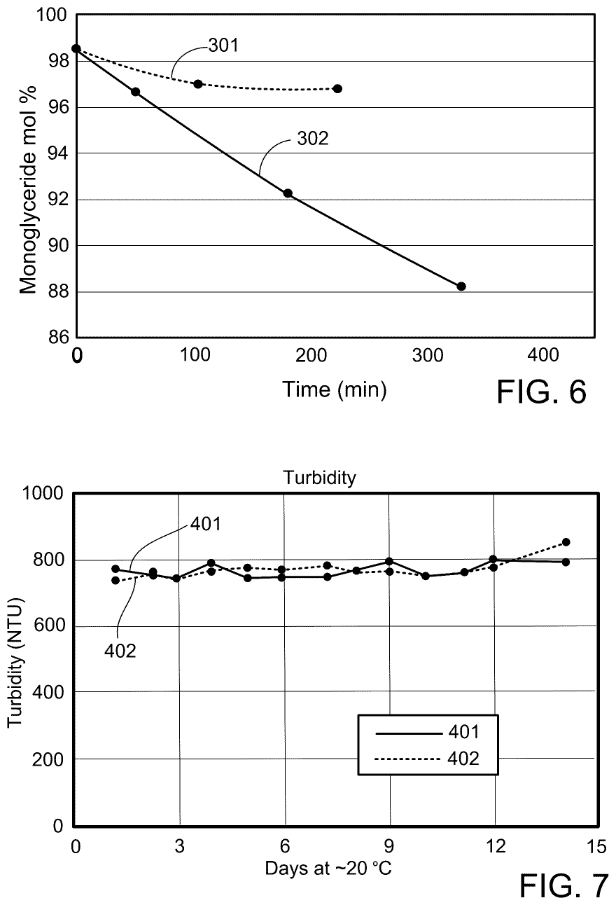

Two compositions were prepared to study the mol % of the total amount of monoglyceride with two different fatty acid salt contents over time. One of the compositions, S1, was prepared according to Example 1. S1 was heated to a temperature of 90° C. and held at that temperature for over 300 minutes. The other composition, Sample 3 (“S3”), was prepared by mixing 3 wt % sodium stearate and 97 wt % glycerol monostearate to form a mixture, wherein the glycerol monostearate was about 80 wt % α-glycerol monostearate and about 20 wt % β-glycerol monostearate, based on the total weight of glycerol monostearate. S3 was then heated to a temperature of 77° C. and held at that temperature for over 200 minutes. The two compositions, S1 and S3, were tested for the mol % of monoglyceride over time, shown in FIG. 6 as plots 302 and 301, respectively. FIG. 6 shows that S3, the sample that was heated at a lower temperature and included a lower percentage of fatty acid, had a much lower percentage of change to the mol % of monoglyceride over time. For example, after heating each sample for 200 minutes, S1 had less than 92 mol % of monoglyceride compared to S3 that had greater than 96 mol % monoglyceride.

FIG. 7 is a graph showing the turbidity of two edible coating compositions of the disclosure. One of the compositions, Sample 4 (“S4”), was prepared by dispersing 5 wt % sodium stearate into 95 wt % melted glycerol monostearate at a temperature of 90° C. to form an edible coating composition, wherein the glycerol monostearate was about 80 wt % α-glycerol monostearate and 20 wt % β-glycerol monostearate, based on the total weight of glycerol monostearate. The edible coating composition was then cooled to a temperature of about −20° C., and was stored for 14 days. The other composition, Sample 5 (“S5”), was prepared by dispersing 5 wt % sodium stearate into 95 wt % melted glycerol monostearate at a temperature of 90° C. to form an edible coating composition, wherein the glycerol monostearate was about 80 wt % α-glycerol monostearate and 20 wt % β-glycerol monostearate, based on the total weight of glycerol monostearate The edible coating composition was then flaked to form flakes. The flakes were cooled to a temperature of about −20° C. and stored for 14 days. Both S4 and S5 were tested for their turbidity over 14 days, as shown in FIG. 7 as plots 401 and 402, respectively. As FIG. 7 shows, both S4 and S5 have a turbidity of about 900 NTU or less for at least 14 days.

Turbidity of the flakes was tested by dispersing the flakes in water to form a mixture, heating the mixture to about 90° C., and blending the mixture for 3 minutes. The resulting liquid was then cooled to room temperature and was used to test turbidity.

### Example 3: Mass Loss Factor of Avocados Coated With Coating Mixtures

Table 1 lists the mass loss factor (“MLF”) of avocados coated with various coating mixtures including edible coating compositions disclosed herein. Each sample represents the average MLF for a group of avocados. The untreated avocados were not treated with a coating mixture. The avocados of Sample 6 (“S6”) and Sample 7 (“S7”) were coated with the compositions listed in Table 1.

To form the coating mixtures, the edible coating compositions were combined with water and admixed together to form the coating mixtures.

To form the coated avocados, the avocados were dip-coated in the coating mixtures. The coated avocados were then allowed to dry in a drying tunnel at a temperature of about 70° C. for about 90 seconds. The coated avocados were kept under ambient room conditions at a temperature in a range of about 23° C.-27° C. and humidity in the range of about 40%-55% for the entire duration of the time they were tested, about 3 days.

The MLF for the untreated avocados is defined as 1.00. The MLFs for the coated avocados with the coating mixtures, S6 and S7, exhibited at least a 45% increase in MLF from the untreated avocados. For example, the avocados coated with the coating mixture of S7 exhibited about a 54% increase in MLF from the untreated avocados.

TABLE 1
Coated Avocados

| | Mass | Edible | | |
|---|---|---|---|---|
| | Loss | Coating | Coating | Mixture |
| Sample | Factor | Composition | Mixture | Form |
| Untreated | | — | — | — |
| S6 | 1.48 | 30 g/L | 95 wt % glyceryl | Blend |
| | | mixture | monostearate (100 | |
| | | in water | wt % β-glycerol | |
| | | | monostearate) and 5 | |
| | | | wt % sodium stearate | |
| S7 | 1.54 | 30 g/L | 95 wt % glyceryl | Flakes |
| | | homogenous | monostearate (about | |
| | | mixture | 80 % α-glycerol | |
| | | in water | monostearate and | |
| | | | 20 % β-glycerol | |
| | | | monostearate) and 5 | |
| | | | wt % sodium stearate | |

### Example 4: Granulating the Edible Coating Composition—Roller Compactor

A monoglyceride (e.g., glycerol monostearate) powder, a fatty acid salt (e.g., sodium stearate) powder, and an additive (e.g., sodium bicarbonate) powder are all sieved and then blended together to form a mixture. The mixture is then fed into a hopper of a roller compactor. The mixture is compressed by two rolls of the roller compactor to form a solid ribbon. After compression, the solid ribbon is then milled and sieved through a mesh of 14 and the edible coating composition is formed, wherein the edible coating composition has an increased bulk density and an increased particle size compared to the bulk density and the particle size of the mixture.

### Example 5: Granulating the Edible Coating Composition—Fluidized Bed

A monoglyceride (e.g., glycerol monostearate) powder, a fatty acid salt (e.g., sodium stearate) powder, and an additive (e.g., sodium bicarbonate) powder are combined in a fluidized bed to form a mixture. The mixture is fluidized by hot air (e.g., 50° C. to 100° C.) in the fluidized bed and in tandem, a liquid binder (e.g., water) is sprayed on the mixture. The mixture is then cooled to room temperature to form the edible coating compositions, wherein the edible coating composition has a decreased bulk density and an increased particle size compared to the bulk density and the particle size of the mixture.

### Example 6: Granulating the Edible Coating Composition—Fluidized Bed

A monoglyceride (e.g., glycerol monostearate) powder, a fatty acid salt (e.g., sodium stearate) powder, and an additive (e.g., sodium bicarbonate) powder are combined in a reservoir to form a mixture. The mixture is sprayed with a liquid binder (e.g., water) while being sheared with a high shear impeller. The mixture is then provided to a fluidized bed and dried to yield the edible coating composition. The edible coating composition has an increased bulk density and an increased particle size compared to the bulk density and the particle size of the mixture.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

### Embodiments

Embodiment 1 is an edible coating composition comprising a multiplicity of particles, each particle comprising a homogeneous mixture of: about 50 wt % to about 98 wt % of one or more monoglycerides; and about 1 wt % to about 10 wt % of one or more fatty acid salts.

Embodiment 2 is the composition of embodiment 1, wherein the homogenous mixture comprises about 80 wt % to about 98 wt %, or 85 wt % to about 98 wt %, or about 90 wt % to about 98 wt %, or about 92 wt % to about 97 wt %, or about 95 wt % of the one or more monoglycerides.

Embodiment 3 is the composition of embodiment 1 or 2, wherein each of the one or more monoglycerides comprises a carbon chain length of C10 to C22.

Embodiment 4 is the composition of any one of embodiments 1-3, wherein each of the one or more monoglycerides independently comprises a carbon chain length of: C10, C12, C14, C16, C18, C20, or C22.

Embodiment 5 is the composition of any one of embodiments 1-4, wherein at least one of the one or more monoglycerides comprises a carbon chain length of C18.

Embodiment 6 is the composition of any one of embodiments 1-5, wherein one of the one or more monoglycerides is glyceryl monostearate.

Embodiment 7 is the composition of embodiment 6, wherein the glyceryl monostearate is present in a molar ratio of at least 60:40, at least 65:35, at least 70:30, at least 75:25, or at least 80:20, of α-glyceryl monostearate to β-glyceryl monostearate.

Embodiment 8 is the composition of any one of embodiments 1-7, wherein each of the one or more fatty acid salts comprises a carbon chain length of C10 to C22.

Embodiment 9 is the composition of any one of embodiments 1-8, wherein each of the one or more fatty acid salts independently comprises a carbon chain length of: C10, C12, C14, C16, C18, C20, or C22.

Embodiment 10 is the composition of any one of embodiments 1-9, wherein at least one of the one or more fatty acid salts comprises a carbon chain length of C18.

Embodiment 11 is the composition of any one of embodiments 1-10, wherein at least one of the one or more fatty acid salts comprises a carbon chain length of C20.

Embodiment 12 is the composition of any one of embodiments 1-11, wherein one of the one or more fatty acid salts is sodium stearate.

Embodiment 13 is the composition of any one of embodiments 1-12, wherein the homogenous mixture further comprises an emulsifier.

Embodiments 14 is the composition of embodiment 13, wherein the emulsifier comprises a phosphate ester.

Embodiment 15 is the composition of embodiment 13 or 14, wherein the emulsifier comprises one or more of lecithin, an ammonium phosphatide, and lysolecithin.

Embodiment 16 is the composition of any one of embodiments 1-15, further comprising sodium chloride.

Embodiment 17 is the composition of any one of embodiments 1-16, further comprising one or more liquid binders.

Embodiment 18 is the composition of any one of embodiments 1-17, wherein the particles are in the form of flakes.

Embodiment 19 is the composition of any one of embodiments 1-18, wherein the particles are in the form of pastilles.

Embodiment 20 is the composition of any one of embodiments 1-19, wherein the total amount of the one or more monoglycerides is about ±3 wt %, ±2 wt %, or ±1 wt % of the total amount of the one or more monoglycerides after the edible coating composition is kept for about 10 days, about 20 days, or about 30 days at room temperature.

Embodiment 21 is a method of preparing an edible coating composition, the method comprising: at least partially melting a material comprising one or more monoglycerides to yield a first mixture; combining the first mixture and one or more fatty acid salts to yield a second mixture; and cooling the second mixture to yield the edible coating composition, wherein the edible coating composition comprises a multiplicity of particles, each particle comprising a homogeneous mixture of the one or more monoglycerides and the one or more fatty acid salts.

Embodiment 22 is the method of embodiment 21, wherein at least partially melting the material comprises heating the mixture to a temperature of about 70° C. to about 100° C. for about 15 minutes to about 3 hours.

Embodiment 23 is the method of embodiment 21 or 22, further comprising mixing the second mixture for a length of time of about 15 minutes to about 1 hour before cooling the second mixture.

Embodiment 24 is the method of embodiment 23, wherein mixing the second mixture occurs for a length of time of less than 1 hour or less than 30 minutes.

Embodiment 25 is the method of any one of embodiments 21-24, wherein cooling the second mixture comprises cooling the second mixture to room temperature or less.

Embodiment 26 is the method of embodiment 25, wherein cooling the second mixture comprises cooling the second mixture to room temperature or less at a rate of about 2° C./minute to about 15° C./minute to yield the edible coating composition.

Embodiment 27 is the method of any one of embodiments 21-26, wherein cooling the second mixture comprises cooling the second mixture to a temperature of about 0° C. to about 20° C.

Embodiment 28 is the method of any one of embodiments 21-27, wherein the edible coating composition is in the form of a solid.

Embodiment 29 is the method of embodiment 28, wherein cooling the second mixture comprises extruding the second mixture.

Embodiment 30 is the method of embodiment 29, wherein the edible coating composition is in the form of compressed aggregates, is partially melted to comprise a mixture of liquid and solid, or is partially melted to comprise a mixture of liquid and semi-solid.

Embodiment 31 is the method of embodiment 29, wherein the edible coating composition is in the form of a liquid melt.

Embodiment 32 is the method of any one of embodiments 29-31, wherein the extruding occurs in a single screw-extruder or a twin-screw extruder.

Embodiment 33 is the method of any one of embodiments 29-32, wherein the extruding comprises heating the second mixture to a temperature in a range of about 70° C. to about 100° C. followed by cooling the second mixture.

Embodiment 34 is the method of any one of embodiments 21-33, wherein cooling the second mixture comprises cooling to a temperature in a range of about 0° C. to about 20° C.

Embodiment 35 is the method of embodiment 33, wherein cooling the second mixture comprises contacting the second mixture directly or indirectly with a surface that is at a temperature in a range of about 0° C. to about 20° C.

Embodiment 36 is the method of any one of embodiments 21-35, wherein the edible coating composition is in the form of flakes, droplets, or pastilles.

Embodiment 37 is a method of preparing an edible coating composition, the method comprising: combining one or more monoglycerides and one or more fatty acid salts to yield a mixture; heating the mixture to at least partially melt the one or more monoglycerides; mixing the mixture to at least partially melt the one or more fatty acid salts; and cooling the mixture to yield the edible coating composition, wherein the edible coating composition comprises a multiplicity of particles, each particle comprising a homogeneous mixture of the one or more monoglycerides and the one or more fatty acid salts.

Embodiment 38 is the method of embodiment 37, wherein heating the mixture to at least partially melt the one or more monoglycerides comprises heating the mixture to a temperature of about 70° C. to about 100° C. for about 15 minutes to about 3 hours.

Embodiment 39 is the method of embodiment 37 or 38, wherein mixing the mixture occurs for less than 1 hour or less than 30 minutes.

Embodiment 40 is the method of any one of embodiments 37-39, wherein cooling the mixture comprises cooling the mixture to room temperature or less.

Embodiment 41 is the method of embodiment 40, wherein cooling the mixture comprises cooling the mixture to room temperature or less at a rate of about 2° C./minute to about 15° C./minute.

Embodiment 42 is the method of any one of embodiments 37-41, wherein cooling the mixture comprises cooling the mixture to a temperature of about 0° C. to about 20° C.

Embodiment 43 is the method of any one of embodiments 37-42, wherein the edible coating composition is in the form of a solid.

Embodiment 44 is the method of embodiment 37-43, wherein cooling the mixture comprises extruding the mixture.

Embodiment 45 is the method of embodiment 44, wherein edible coating composition is in the form of compressed aggregates, a mixture of liquid and solid, or a mixture of liquid and semi-solid.

Embodiment 46 is the method of embodiment 44, wherein the edible coating composition is in the form of a liquid melt.

Embodiment 47 is the method of any one of embodiments 44-46, wherein the extruding occurs in a single screw-extruder or a twin-screw extruder.

Embodiment 48 is the method of any one of embodiments 44-47, wherein the extruding comprises heating the mixture to a temperature in a range of about 70° C. to about 100° C. followed by cooling the mixture.

Embodiment 49 is the method of any one of embodiments 37-48, wherein cooling the mixture comprises cooling to a temperature in a range of about 0° C. to about 20° C.

Embodiment 50 is the method of embodiment 49, wherein cooling the mixture comprises contacting the mixture directly or indirectly with a surface that is at a temperature in a range of about 0° C. to about 20° C.

Embodiment 51 is the method of any one of embodiments 37-50, wherein the edible coating composition is in the form of flakes, droplets, or pastilles.

Embodiment 52 is a method of preparing a coating mixture, the method comprising: combining a crystalline form of the edible coating composition of claim 1 and water to form the coating mixture.

Embodiment 53 is the method of embodiment 52, wherein the total amount of the one or more monoglycerides is about ±3 wt %, ±2 wt %, or ±1 wt % of the total amount of the one or more monoglycerides after the edible coating composition is kept for about 10 days, about 20 days, or about 30 days at room temperature.

Embodiment 54 is the method of embodiment 52 or 53, wherein the coating mixture has a turbidity less than 2000 nephelometric turbidity unit.

Embodiment 55 is the method of any one of embodiments 52-54, wherein the coating mixture comprises about 1 wt % to about 20 wt % water.

Embodiment 56 is the method of any one of embodiments 52-55, further comprising coating an agricultural product with the coating mixture to yield a coated agricultural product.

Embodiment 57 is the method of embodiment 56, wherein the coated agricultural product has a mass loss factor of at least 1.50 or at least 1.55.

Embodiment 58 is a method of preparing an edible coating composition, the method comprising: combining one or more particulate monoglycerides and one or more particulate fatty acid salts to yield a mixture comprising a multiplicity of particles; and granulating the mixture to yield the edible coating composition.

Embodiment 59 is the method of embodiment 58, wherein the multiplicity of particles are in the form of a powder, a liquid, a wax, a pellet, or a combination thereof.

Embodiment 60 is the method of embodiment 58 or 59, wherein granulating the mixture comprises dry granulation, fluidized bed granulation, or high shear granulation.

Embodiment 61 is the method of embodiment 60, wherein granulating the mixture comprises dry granulation to yield the edible coating composition, and further comprising compacting the edible coating composition with a force of 2000 pounds to 5000 pounds to yield an aggregate.

Embodiment 62 is the method of any one of embodiments 58-61, further comprising milling and sieving the edible coating composition to a particle size of about 800 microns to about 1500 microns, about 840 microns to about 1410 microns, about 800 microns to about 1000 microns, or about 1050 microns to about 1450 microns.

Embodiment 63 is the method of any one of embodiments 58-62, further comprising contacting a liquid binder with the mixture during the granulating.

Embodiment 64 is the method of any one of embodiments 58-63, further comprising drying the edible coating composition in a fluidized bed.

Embodiment 65 is the method of any one of embodiments 58-64, wherein the edible coating composition has a bulk density that exceeds the bulk density of the multiplicity of particles prior to granulation.

Embodiment 66 is the method of any one of embodiments 58-65, wherein the edible coating composition has a particle size that exceeds the particle size of the multiplicity of particles prior to granulation.

Embodiment 67 is the method of any one of embodiments 58-66, wherein the edible coating composition has a flowability with a Hausner Ratio of 1 to 1.34 or a Carr Index less than 25.

Embodiment 68 is the method of embodiment 58 further comprising combining the one or more particulate monoglycerides and the one or more particulate fatty acid salts with one or more particulate emulsifiers.

Embodiment 69 is the method of claim 68, further comprising granulating each of the one or more particulate monoglycerides, one or more particulate fatty acid salts, and one or more particulate emulsifiers prior to combining.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An edible coating composition comprising a multiplicity of particles, each particle comprising a homogeneous mixture of:
about 50 wt % to about 98 wt % of one or more monoglycerides; and
about 1 wt % to about 10 wt % of one or more fatty acid salts.

2. The composition of claim 1, wherein the homogenous mixture comprises about 80 wt % to about 98 wt %, 85 wt % to about 98 wt %, about 90 wt % to about 98 wt %, about 92 wt % to about 97 wt %, or about 95 wt % of the one or more monoglycerides.

3. The composition of claim 1, wherein each of the one or more monoglycerides comprises a carbon chain length of C10 to C22.

4. The composition of claim 1, wherein one of the one or more monoglycerides is glyceryl monostearate.

5. The composition of claim 4, wherein the glyceryl monostearate is present in a molar ratio of at least 60:40, at least 65:35, at least 70:30, at least 75:25, or at least 80:20 of α-glyceryl monostearate to β-glyceryl monostearate.

6. The composition of claim 1, wherein each of the one or more fatty acid salts comprises a carbon chain length of C10 to C22.

7. The composition of claim 1, wherein one of the one or more fatty acid salts is sodium stearate.

8. The composition of claim 1, wherein the homogenous mixture further comprises an emulsifier.

9. The composition of claim 8, wherein the emulsifier comprises a phosphate ester.

10. The composition of claim 8, wherein the emulsifier comprises one or more of lecithin, an ammonium phosphatide, and lysolecithin.

11. The composition of claim 1, wherein the edible coating composition further comprises sodium chloride.

12. The composition of claim 1, wherein the edible coating composition further comprises one or more liquid binders.

13. The composition of claim 1, wherein the particles are in the form of flakes.

14. The composition of claim 1, wherein the particles are in the form of pastilles.

15. The composition of claim 1, wherein a total amount of the one or more monoglycerides is about ±3 wt %, ±2 wt %, or ±1 wt % of the total amount of the one or more monoglycerides after the edible coating composition is kept for about 10 days, about 20 days, or about 30 days at room temperature.

16. A method of preparing an edible coating composition, the method comprising:
at least partially melting a material comprising one or more monoglycerides to yield a first mixture;
combining the first mixture and one or more fatty acid salts to yield a second mixture; and
cooling the second mixture to yield the edible coating composition, wherein the edible coating composition comprises a multiplicity of particles, each particle comprising a homogeneous mixture of the one or more monoglycerides and the one or more fatty acid salts.

17. A method of preparing an edible coating composition, the method comprising:
combining one or more monoglycerides and one or more fatty acid salts to yield a mixture;
heating the mixture to at least partially melt the one or more monoglycerides;
mixing the mixture to at least partially melt the one or more fatty acid salts; and
cooling the mixture to yield the edible coating composition, wherein the edible coating composition comprises a multiplicity of particles, each particle comprising a homogeneous mixture of the one or more monoglycerides and the one or more fatty acid salts.

18. A method of preparing a coating mixture, the method comprising:
combining a crystalline form of the edible coating composition of claim 1 and water to form the coating mixture.

19. A method of preparing the edible coating composition of claim 1, the method comprising:
combining one or more particulate monoglycerides and one or more particulate fatty acid salts to yield a mixture comprising a multiplicity of particles; and
granulating the mixture to yield the edible coating composition.
